(19) United States
(12) Patent Application Publication
(10) Pub. No.: US 2024/0422625 A1
(43) Pub. Date: Dec. 19, 2024

(54) Method and Apparatus for Implementing Sensing QOS and Communication Device

(71) Applicant: VIVO MOBILE COMMUNICATION CO., LTD., Guangdong (CN)

(72) Inventors: Yannan Yuan, Guangdong (CN); Jianming Wu, Guangdong (CN)

(21) Appl. No.: 18/819,315

(22) Filed: Aug. 29, 2024

Related U.S. Application Data
(63) Continuation of application No. PCT/CN2023/078223, filed on Feb. 24, 2023.

(30) Foreign Application Priority Data
Mar. 3, 2022 (CN) 202210203762.6

(51) Int. Cl. H04W 28/24; H04W 24/10

(52) U.S. Cl. CPC H04W 28/24; H04W 24/10

(57) ABSTRACT

This application discloses a method and an apparatus for implementing sensing QoS and a communication device. The method for implementing sensing QoS in the embodiments of this application includes: A sensing function instance obtains sensing QoS information, where the sensing QoS information includes sensing QoS information related to sensing data transmission; and the sensing function instance determines configuration information of the sensing data transmission based on the sensing QoS information, or sends the sensing QoS information to a first network function instance.

### CROSS-REFERENCE TO RELATED APPLICATIONS

This application is a Bypass continuation application of PCT International Application No. PCT/CN2023/078223 filed on Feb. 24, 2023, which claims priority to Chinese Patent Application No. 202210203762.6, filed on Mar. 3, 2022 in China, which is incorporated herein by reference in its entirety.

### TECHNICAL FIELD

This application relates to the field of wireless communication technologies, and in particular, to a method and an apparatus for implementing sensing QoS and a communication device.

### BACKGROUND OF THE INVENTION

A future mobile communication system, such as a beyond fifth-generation mobile communication system (B5G) or a sixth-generation mobile communication system (6G), may have a sensing capability in addition to a communication capability. The sensing capability is that one or more devices with the sensing capability can sense information such as a direction, a distance, and/or a speed of a target object by sending and receiving a wireless signal, or detect, track, identify, or image a target object, an event, an environment, or the like. In the future, with the deployment of a small base station with a capability of a high frequency band and high bandwidth such as millimeter wave and terahertz in a 6G network, resolution of sensing is significantly improved when compared with that of a centimeter wave, so that the 6G network can provide a more precise sensing service.

A technical solution needs to be provided for how to implement a potential quality of service (QOS) interaction process.

### SUMMARY OF THE INVENTION

Embodiments of this application provide a method and an apparatus for implementing sensing QoS and a communication device.

According to a first aspect, a method for implementing sensing QoS is provided, including:
obtaining, by a sensing function instance, sensing QoS information, where the sensing QoS information includes sensing QoS information related to sensing data transmission; and
determining, by the sensing function instance, configuration information of the sensing data transmission based on the sensing QoS information, or sending the sensing QoS information to a first network function instance.

According to a second aspect, a method for implementing sensing QoS is provided, including:
receiving, by a first network function instance, sensing QoS information, where the sensing QoS information includes sensing QoS information related to sensing data transmission; and
establishing and/or modifying, by the first network function instance, a sensing data transmission channel based on the sensing QoS information, and/or determining configuration information of the sensing data transmission.

According to a third aspect, an apparatus for implementing sensing QoS is provided, including:
a first obtaining module, configured to obtain sensing QoS information, where the sensing QoS information includes sensing QoS information related to sensing data transmission; and
a first decision module, configured to determine configuration information of the sensing data transmission based on the sensing QoS information; or a first sending module, configured to send the sensing QoS information to a first network function instance.

According to a fourth aspect, an apparatus for implementing sensing QoS is provided, including:
a first receiving module, configured to receive sensing QoS information, where the sensing QoS information includes sensing QoS information related to sensing data transmission; and
a first processing module, configured to: establish and/or modify a sensing data transmission channel based on the sensing QOS information, and/or determine configuration information of the sensing data transmission.

According to a fifth aspect, a communication device is provided, including a processor and a memory. The memory stores a program or an instruction that can be run on the processor, and when the program or the instruction is executed by the processor, the steps of the method for implementing sensing QoS according to the first aspect or the second aspect are implemented.

According to a sixth aspect, a communication device is provided, including a processor and a communication interface. The processor is configured to: obtain sensing QoS information, where the sensing QoS information includes sensing QoS information related to sensing data transmission; and determine configuration information of the sensing data transmission based on the sensing QoS information. Alternatively, the communication interface is configured to send the sensing QoS information to a first network function instance.

According to a seventh aspect, a communication device is provided, including a processor and a communication interface. The communication interface is configured to receive sensing QoS information, where the sensing QoS information includes sensing QoS information related to sensing data transmission. The processor is configured to: establish and/or modify a sensing data transmission channel based on the sensing QoS information, and/or determine configuration information of the sensing data transmission.

According to an eighth aspect, a readable storage medium is provided, where the readable storage medium stores a program or an instruction, and when the program or the instruction is executed by a processor, the steps of the method according to the first aspect or the second aspect are implemented.

According to a ninth aspect, a chip is provided. The chip includes a processor and a communication interface, the communication interface is coupled to the processor, and the processor is configured to run a program or an instruction, to implement the method according to the first aspect or the second aspect.

According to a tenth aspect, a computer program/program product is provided. The computer program/program product is stored in a storage medium, and the computer program/program product is executed by at least one processor to implement the steps of the method according to the first aspect or the second aspect.

### BRIEF DESCRIPTION OF DRAWINGS

FIG. 1 is a block diagram of a wireless communication system to which embodiments of this application may be applied;

FIG. 2 is a first schematic flowchart of a method for implementing sensing Qos according to an embodiment of this application;

FIG. 3 is a second schematic flowchart of a method for implementing sensing Qos according to an embodiment of this application;

FIG. 4 is a schematic diagram of a method for mapping sensing QoS according to an embodiment of this application;

FIG. 5a is a first schematic diagram of a structure of an apparatus for implementing sensing QoS according to an embodiment of this application;

FIG. 5b is a second schematic diagram of a structure of an apparatus for implementing sensing QoS according to an embodiment of this application;

FIG. 6 is a third schematic diagram of a structure of an apparatus for implementing sensing QoS according to an embodiment of this application;

FIG. 7 is a schematic diagram of a structure of a communication device according to an embodiment of this application;

FIG. 8 is a schematic diagram of a hardware structure of a network side device in a radio access network according to an embodiment of this application; and

FIG. 9 is a schematic diagram of a hardware structure of a network side device in a core network according to an embodiment of this application.

### DETAILED DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a long term evolution (LTE)/LTE-advanced (LTE-A) system, and may further be applied to other wireless communication systems such as code division multiple access (CDMA), time division multiple access (TDMA), frequency division multiple access (FDMA), orthogonal frequency division multiple access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the term NR is used in most of the following description, although these technologies can also be applied to applications other than the NR system application, such as a 6^{th} generation (6G) communication system.

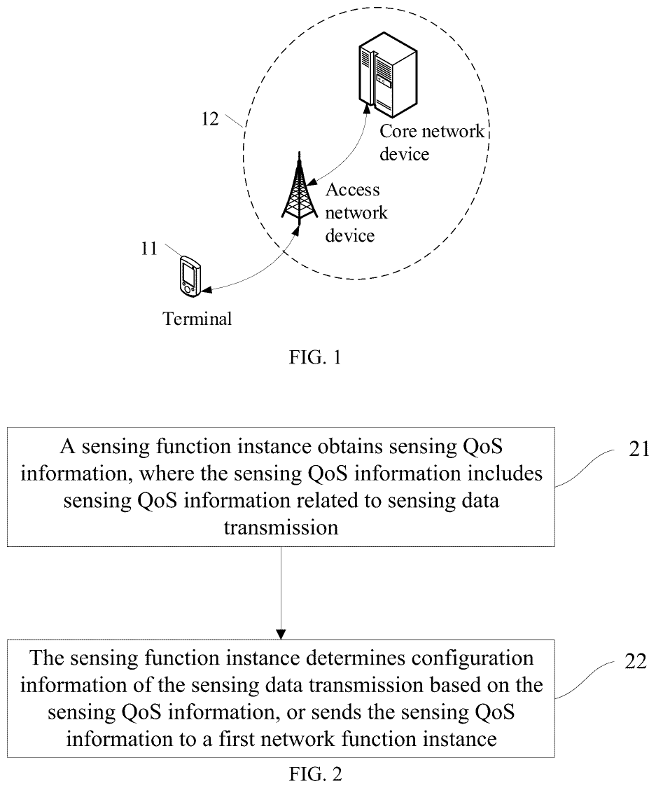

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer that is also referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle-mounted user equipment (VUE), pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a WiFi node, and the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another proper term in the art. The base station is not limited to a specific technical vocabulary provided that a same technical effect is achieved. It should be noted that in the embodiments of this application, a base station in an NR system is merely used as an example for description, but does not limit a specific type of the base station. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (PCRF), an edge application service discovery function (EASDF), unified data management (UDM), unified data repository (UDR), a home subscriber server (HSS), centralized network configuration (CNC), a network repository function (NRF), a network exposure function (NEF), a local NEF (L-NEF), a binding support function (BSF), an application function (AF), and the like. It should be noted that, in the embodiments of this application, only a core network device in the NR system is used as an example for description, and a specific type of the core network device is not limited.

Related communication terms related to this application are briefly described below.

### 1. Positioning QoS

Current positioning includes key performance indicators (KPI) corresponding to different positioning service levels. Main KPIs are shown in Table 1.

TABLE 1
Performance requirements of horizontal and vertical positioning service levels

| | | Accuracy | | | | Position- | | | | | |
|---|---|---|---|---|---|---|---|---|---|---|---|
| Position- | Absolute(A) | (95% confidence level) | | | | ing | Position- | | | | |
| ing | or | | | Vertical | | Service | ing | | Coverage, environment of use and UE velocity | | |
| service | Relative(R) | Horizontal | | Accuracy | | avail- | Service | | 5G positioning | 5G enhanced positioning service area (note 2) | |
| level | positioning | Accuracy | | (note 1) | | ability | latency | | service area | Outdoor and tunnels | Indoor |
| 1 | Absolute | 10 | m | 3 | m | 95% | 1 | s | Indoor - up to 30 km/h | NA | Indoor - up |
| | | | | | | | | | Outdoor (rural and | | to 30 km/h |
| | | | | | | | | | urban) up to 250 km/h | | |
| 2 | Absolute | 3 | m | 3 | m | 99% | 1 | s | Outdoor (rural and | Outdoor (dense urban) | Indoor - up |
| | | | | | | | | | urban) up to 500 km/h | up to 60 km/h | to 30 km/h |
| | | | | | | | | | for trains and up to | Along roads up to | |
| | | | | | | | | | 250 km/h for other | 250 km/h and along | |
| | | | | | | | | | vehicles | railways up to 500 km/h | |
| 3 | Absolute | 1 | m | 2 | m | 99% | 1 | s | Outdoor (rural and | Outdoor (dense urban) | Indoor - up |
| | | | | | | | | | urban) up to 500 km/h | up to 60 km/h | to 30 km/h |
| | | | | | | | | | for trains and up to | Along roads up to | |
| | | | | | | | | | 250 km/h for other | 250 km/h and along | |
| | | | | | | | | | vehicles | railways up to 500 km/h | |
| 4 | Absolute | 1 | m | 2 | m | 99.9% | 15 | ms | NA | NA | Indoor - up |
| | | | | | | | | | | | to 30 km/h |
| 5 | Absolute | 0.3 | m | 2 | m | 99% | 1 | s | Outdoor (rural) up to | Outdoor (dense urban) | Indoor - up |
| | | | | | | | | | 250 km/h | up to 60 km/h | to 30 km/h |
| | | | | | | | | | | Along roads and along | |
| | | | | | | | | | | railways up to 250 km/h | |
| 6 | Absolute | 0.3 | m | 2 | m | 99.9% | 10 | ms | NA | Outdoor (dense urban) | Indoor - up |
| | | | | | | | | | | up to 60 km/h | to 30 km/h |

| | | | | | | | | | |
|---|---|---|---|---|---|---|---|---|---|
| 7 | Relative | 0.2 | m | 0.2 | m | 99% | 1 | s | Indoor and outdoor (rural, urban, dense urban) up to 30 km/h |
| | | | | | | | | | Relative positioning is between two UEs within 10 m of each |
| | | | | | | | | | other or between one UE and 5G positioning nodes within 10 m |
| | | | | | | | | | of each other (note 3) |

NOTE 1:
The objective for the vertical positioning requirement is to determine the floor for indoor use cases and to distinguish between superposed tracks for road and rail use cases (e.g. bridges).
NOTE 2:
Indoor includes location inside buildings such as offices, hospital, industrial buildings.
NOTE 3:
5G positioning nodes are infrastructure equipment deployed in the service area to enhance positioning capabilities (e.g. beacons deployed on the perimeter of a rendezvous area or on the side of a warehouse).

Positioning accuracy is used to indicate error distribution of performance of positioning services, and is defined by using a confidence level and a positioning error threshold, that is, a percentage of a distance between a positioning result and an actual location within a positioning error threshold range. For example, the positioning accuracy is <3 m, and 95% confidence level indicates that 95% of all calculated positioning results are less than 3 meters away from the actual location. However, distances between the other 5% positioning results and the actual location are unknown or cannot be ensured.

Positioning QoS is included in a location request, including a location request of a positioning demand side and a location request of a positioning result provider, that is, a local management function (LMF). The location request of the LMF is generated based on the location request of the positioning demand side.

The location request of the positioning demand side (a location service (LCS) client or an application function (AF)) may include the following parameter indicators:
(1) QoS type/class (LCS QoS Class);
a) a best effort type, which is the least stringent positioning QoS type, where if a positioning result cannot meet other QoS indicator requirements, the positioning result still needs to be fed back, but an indication is required to indicate that requested QoS is not met, and if the positioning result is not obtained, a fault cause is fed back;
b) a multiple QoS type: which is a intermediate stringent positioning QoS type, that is, QoS indicator requirements corresponding to a plurality of QoS classes are included, where if a positioning result does not meet the most stringent QoS indicator requirement, the LMF initiates a positioning procedure again, to attempt to meet a lower QoS indicator requirement until one of the QoS indicator requirements is met, and if the least stringent QoS indicator requirement is still not met, the LMF does not feed back the positioning result, but feeds back only a failure cause;
c) an assured type; and the most stringent positioning QoS type. If a positioning result cannot meet other QoS indicator requirements, the positioning result is not fed back, but only a failure cause is fed back.
(2) The positioning accuracy includes horizontal positioning accuracy and/or vertical positioning accuracy.
(3) Response time type: The LMF needs to balance positioning accuracy and a response time type.
a) No delay: The LMF needs to immediately feed back an initial location or a latest positioning result of target UE. If there is no positioning result, failure information is fed back, and a positioning procedure may be triggered to respond to a subsequent location request.
b) Low delay: Compared with accuracy, a response time requirement is preferably met. An LCS server needs to return a current location with a minimum delay.
c) Delay insensitive: Compared with response time, an accuracy requirement is preferably met. The LMF may delay the feedback of the positioning result until a required positioning accuracy requirement is met.

The location request of the LMF may include the following parameter indicators:
(1) Horizontal positioning accuracy (HorizontalAccuracy), including accuracy and confidence;
(2) Vertical positioning accuracy (VerticalAccuracy), including accuracy and confidence; and
(3) Response time, which is a delay from receiving of a location request by the UE to providing positioning information.

### 2. 5G QOS:

### 5G QoS Parameters are Shown as Follows:

(1) Resource type (a non-guaranteed bit rate (Guaranteed Bit Rate, GBR), a GBR, and a delay-critical GBR);
(2) Priority;
(3) Packet delay budget (including core network packet delay budget);
(4) Packet error rate;
(5) Averaging window (only applicable to the GBR and delay-critical GBR resource types);
(6) Maximum data burst volume (only applicable to the delay-critical GBR resource type).

Mapping between a 5G QoS identifier (5QI) defined in a protocol standard and a QoS parameter set is shown in Table 2. In actual deployment, an operator may customize a QoS class based on the QoS parameter set.

TABLE 2
Mapping between a 5QI and a QoS parameter set

| | | | | | Default | | |
|---|---|---|---|---|---|---|---|
| | | Default | | Packet | Maximum Data | Default | |
| 5QI | Resource | priority | Packet delay budget | error | Burst Volume | averaging | |
| Value | type | level | (NOTE 3) | rate | (NOTE 2) | window | Example services |
| 1 | GBR | 20 | 100 ms (NOTE 11, | 10−2 | N/A | 2000 ms | Conversational Voice |
| | | | NOTE 13) | | | | |
| 2 | (NOTE 1) | 40 | 150 ms (NOTE 11, | 10−3 | N/A | 2000 ms | Conversational Video (Live Streaming) |
| | | | NOTE 13) | | | | |
| | | 30 | 50 ms (NOTE 11, | 10−3 | N/A | 2000 ms | Real Time Gaming, V2X messages |
| | | | NOTE 13) | | | | (see TS 23.287 [121]). |
| | | | | | | | Electricity distribution - medium |
| | | | | | | | voltage, Process automation monitoring |
| 4 | | 50 | 300 ms (NOTE 11, | 10−6 | N/A | 2000 ms | Non-Conversational Video |
| | | | NOTE 13) | | | | (Buffered Streaming) |
| 65 (NOTE 9, | | 7 | 75 ms (NOTE 7, | 10−2 | N/A | 2000 ms | Mission Critical user plane Push |
| NOTE 12) | | | NOTE 8) | | | | To Talk voice (e.g., MCPTT) |
| 66 (NOTE 12) | | 20 | 100 ms (NOTE 10, | 10−2 | N/A | 2000 ms | Non-Mission-Critical user plane Push |
| | | | NOTE 13) | | | | To Talk voice |
| 67 (NOTE 12) | | 15 | 100 ms (NOTE 10, | 10−3 | N/A | 2000 ms | Mission Critical Video user plane |
| | | | NOTE 13) | | | | |
| 75 (NOTE 14) | | | | | | | |
| 71 | | 56 | 150 ms (NOTE 11, | 10−6 | N/A | 2000 ms | “Live” Uplink Streaming |
| | | | NOTE 13, NOTE 15) | | | | (e.g. TS 26.238 [76]) |
| 72 | | 56 | 300 ms (NOTE 11, | 10−4 | N/A | 2000 ms | “Live” Uplink Streaming |
| | | | NOTE 13, NOTE 15) | | | | (e.g. TS 26.238 [76]) |
| 73 | | 56 | 300 ms (NOTE 11, | 10−8 | N/A | 2000 ms | “Live” Uplink Streaming |
| | | | NOTE 13, NOTE 15) | | | | (e.g. TS 26.238 [76]) |
| 74 | | 56 | 500 ms (NOTE 11, | 10−8 | N/A | 2000 ms | “Live” Uplink Streaming |
| | | | NOTE 15) | | | | (e.g. TS 26.238 [76]) |
| 76 | | 56 | 500 ms (NOTE 11, | 10−4 | N/A | 2000 ms | “Live” Uplink Streaming |
| | | | NOTE 13, NOTE 15) | | | | (e.g. TS 26.238 [76]) |
| 5 | Non- | 10 | 100 ms NOTE 10, | 10−6 | N/A | N/A | IMS Signaling |
| | GBR | | NOTE 13) | | | | |
| 6 | (NOTE 1) | 60 | 300 ms (NOTE 10, | 10−6 | N/A | N/A | Video (Buffered Streaming) |
| | | | NOTE 13) | | | | TCP-based (e.g., www, e-mail, chat, |
| | | | | | | | ftp, p2p file sharing, progressive |
| | | | | | | | video, etc.) |
| 7 | | 70 | 100 ms (NOTE 10, | 10−3 | N/A | N/A | Voice, |
| | | | NOTE 13) | | | | Video (Live Streaming) |
| | | | | | | | Interactive Gaming |
| 8 | | 80 | 300 ms (NOTE 13) | 10−6 | N/A | N/A | Video (Buffered Streaming) |
| | | | | | | | TCP-based (e.g., www, e-mail, chat, |
| | | | | | | | ftp, p2p file sharing, progressive |
| 9 | | 90 | | | | | Video, etc.) |
| 69 (NOTE 9, | | 5 | 60 ms (NOTE 7, | 10−6 | N/A | N/A | Mission Critical delay sensitive |
| NOTE 12) | | | NOTE 8) | | | | signaling (e.g., MC-PTT signaling) |
| 70 (NOTE 12) | | 55 | 200 ms (NOTE 7, | 10−6 | N/A | N/A | Mission Critical Data (e.g. example |
| | | | NOTE 10) | | | | services are the same as 5QI 6/8/9) |
| 79 | | 65 | 50 ms (NOTE 10, | 10−2 | N/A | N/A | V2X messages (see TS 23.287 [121]) |
| | | | NOTE 13) | | | | |
| 80 | | 68 | 10 ms (NOTE 5, | 10−6 | N/A | N/A | Low Latency eMBB applications |
| | | | NOTE 10) | | | | Augmented Reality |
| 82 | Delay- | 19 | 10 ms (NOTE 4) | 10−4 | 255 bytes | 2000 ms | Discrete Automation |
| | critical | | | | | | (see TS 22.261 [2]) |
| | GBR | | | | | | |
| 83 | | 22 | 10 ms (NOTE 4) | 10−4 | 1354 bytes | 2000 ms | Discrete Automation |
| | | | | | (NOTE 3) | | (see TS 22.261 [2]); V2X messages |
| | | | | | | | (UE - RSU Platooning, Advanced Driving: |
| | | | | | | | Cooperative Lane Change with low LoA. |
| | | | | | | | See TS 22.186 [111], TS 23.287 [121]) |
| 84 | | 24 | 30 ms (NOTE 6) | 10−5 | 1354 bytes | 2000 ms | Intelligent transport systems |
| | | | | | (NOTE 3) | | (see TS 22.261 [2]) |
| 85 | | 21 | 5 ms (NOTE 5) | 10−5 | 255 bytes | 2000 ms | Electricity Distribution- high voltage |
| | | | | | | | (see TS 22.261 [2]). V2X messages |
| | | | | | | | (Remote Driving. See TS 22.186 [111], |
| | | | | | | | NOTE 16, see TS 23.287 [121]) |
| 86 | | 18 | 5 ms (NOTE 5) | 10−4 | 1354 bytes | 2000 ms | V2X messages (Advanced Driving: Collision |
| | | | | | | | Avoidance, Platooning with high LoA. |
| | | | | | | | See TS 22.186 [111], TS 23.287 |
| | | | | | | | [121]) |

Quality of Service (QOS) means that a network provides a better service capability for specified network communication by using various underlying technologies, to resolve problems such as a network latency and blocking, thereby implementing a transmission capability guarantee mechanism required by a specific service. During network congestion, all data flows may be discarded. To meet requirements of different applications and different quality of service of users, the network needs to allocate and schedule resources based on the requirements of the users, and provide different quality of service for different data flows. An important data packet with strong real-time performance is processed first. For a common data packet with low real-time performance, a lower processing priority is provided, and is discarded during network congestion.

QoS is a technical concept drawn from the Internet. An International Telecommunication Union (ITU) provides a definition of QoS in the x.902 standard, that is “Information technology-Open Distributed Processing-Reference model”: a set of quality requirements on collective behavior of one or more objects. Some quality of service parameters such as a throughput, a transmission delay, and an error rate describe a speed and reliability of data transmission.

LTE is a bearer-based QoS policy design. Radio bearers are classified into a signaling radio bearer (SRB) and a data radio bearer (DRB). The SRB is used for signaling transmission, the DRB is used for data transmission, and scheduling priorities of all SRBs are higher than those of all DRBs. A QoS class identifier (QCI) is a parameter used by a system to identify a service data packet transmission characteristic, and QCI values corresponding to different bearer services are defined in the protocol TS 23.203. Based on different QCIs, bearers may be classified into two types: a guaranteed bit rate (GBR)-type bearer and a non-GBR-type bearer. The GBR-type bearer is used for a service with a relatively high real-time performance requirement. A scheduler needs to ensure a lowest bit rate for this type of bearer. A range of a QCI of the GBR-type bearer is 1 to 4. In addition to this lowest rate, a highest rate is further required for limitation. For a GBR bearer, a maximum bit rate (MBR) is used to limit a maximum rate of the bearer. An MBR parameter defines an upper rate limit that the GBR bearer can reach when there are sufficient RB resources. A value of the MBR is greater than or equal to a value of the GBR. The non-GBR-type bearer is used for a service with a low real-time performance requirement. A scheduler does not need to ensure a lowest bit rate for this type of bearer. A range of a QCI of the non-GBR-type bearer is 5 to 9. In a case of network congestion, a service needs to bear a requirement of reducing a rate. For non-GBR, an aggregate maximum bit rate (UE-AMBR) is used to limit maximum rates of all non-GBR bearers.

5G QOS characteristics are a characteristic parameter set obtained when each network node (a terminal (UE), a base station (gNB), or a user plane function (UPF)) processes each QoS flow. A 5G characteristic parameter set is divided into a standardized QoS characteristic and an operator-specific QoS characteristic. For the former, a value of each parameter is pre-defined through standardization and associated with a fixed 5QI value (an index for marking a series of parameters). For the latter, a value of each parameter is configured by an operator. An In-band QoS marking mechanism of a data flow is used in 5G. Based on a QoS requirement of a service, a gateway or an APP server marks a corresponding QoS processing label of the data flow. A network side performs data packet forwarding based on the QoS label. The QoS label may change in real time based on the requirement of the service data flow to meet the service requirement in real time. A non-access stratum (NAS) of a GW (gateway) maps a plurality of IP flows with a same QoS requirement into a same QoS flow. A gNB maps the QoS flow into a DRB, so that a wireless side adapts to the QoS requirement. A RAN side has a specific degree of freedom. For example, the gNB can convert a QoS flow into a DRB. Downlink mapping belongs to network implementation. Uplink mapping is based on reflective QoS or RRC configuration. A 5G QoS model also supports a QoS flow of a guaranteed flow bit rate (GBR QoS) and a QoS flow of a non-guaranteed flow bit rate (Non-GBR). An aggregated maximum bit rate (AMBR) is also used to limit total bandwidth of the non-GBR. The 5G QoS model also supports reflected QoS.

A method and an apparatus for implementing sensing QoS and a communication device provided in the embodiments of this application are described in detail below with reference to the accompanying drawings by using specific embodiments and application scenarios thereof.

As shown in FIG. 2, an embodiment of this application further provides a method for implementing sensing QoS, including the following steps:

Step 21: A sensing function instance obtains sensing QoS information, where the sensing QoS information includes sensing QoS information related to sensing data transmission.

In this embodiment of this application, the sensing QoS information related to the sensing data transmission may also be referred to as a sensing data transmission QoS parameter.

Step 22: The sensing function instance determines configuration information of the sensing data transmission based on the sensing QoS information, or sends the sensing QoS information to a first network function instance.

In this embodiment of this application, the configuration information of the sensing data transmission can be determined based on the sensing QoS information, or the sensing QoS information is sent to the first network function instance, to trigger the first network function instance to establish and/or modify a sensing data transmission channel, thereby helping a sensing node complete reporting of a sensing measurement quantity to obtain a sensing result. Therefore, a sensing QoS requirement of a sensing service is met.

In this embodiment of this application, optionally, the configuration information of the sensing data transmission includes at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data;
a burst volume of sensing data;
a time-domain and/or frequency-domain resource used in sensing data transmission; and
a physical layer parameter used in sensing data transmission, including at least one of a modulation and coding scheme MCS, a precoding indication, a timing advance TA, and power.

A typical sensing function and an application scenario are shown in Table 3.

TABLE 3

| Communication | | |
|---|---|---|
| sensing category | Sensing function | Application scenario |
| Macro sensing | Weather conditions, air quality, | Meteorology, agriculture, and life |
| type | and the like | services |
| | Traffic flow (intersections) and | Intelligent traffic and commercial |
| | flow of people (subway entrances) | services |
| | Target tracking, ranging, speed | Many application scenarios for |
| | measurement, contours, and the | conventional radars |
| | like | |
| | Environment reconstruction | Intelligent driving and navigation |
| | | (car/unmanned aerial vehicles), smart |
| | | city (3-dimensional map), and network |
| | | planning and optimization |
| Fine sensing | Action/posture/expression | Intelligent interaction of smartphones, |
| type | recognition | games, and smart home |
| | Heartbeat/breathing and the like | Health and medical care |
| | Imaging, material detection, | Security inspection, industry, |
| | component analysis, and the like | biological medicine, and the like |

Descriptions of quality of service requirements of the sensing service are different. For example, sensing such as intelligent traffic or a high-precision map is generally expressed by a sensing range, distance resolution, angle resolution, speed resolution, and a delay. Flight intrusion detection sensing is usually expressed by coverage height, sensing accuracy, and a sensing delay. Respiration monitoring is expressed by a sensing distance, sensing real-time performance, sensing resolution, and sensing accuracy. Indoor intrusion detection is expressed by a sensing distance, sensing real-time performance, a detection probability, and a false alarm probability. Gesture/posture recognition is expressed by a sensing distance, sensing real-time performance, and sensing accuracy.

In an existing technical solution, positioning QoS is mainly defined from positioning quality concerned by a location requester, and communication QoS is defined from user plane data transmission quality. Sensing services currently under discussion are of rich and diverse types, which indicates that sensing QoS of performance of different sensing services varies greatly in terms of types and quantities. A technical solution needs to be provided for how to define sensing QoS from a plurality of dimensions and a relationship between sensing QoS in all dimensions.

In this embodiment of this application, optionally, the sensing QoS information includes at least one of the following:

### (1) Priority of Sensing Data

The sensing data includes at least a measurement result of a sensing measurement quantity generated by sensing signal measurement. The priority of the sensing data is used by a core network and/or a radio access network to schedule resources for a plurality of sensing data transmission channels, and/or jointly schedule a sensing data transmission resource and a communication data transmission resource.

### (2) Type of Sensing Data

The sensing data includes at least a measurement result of a sensing measurement quantity generated by sensing signal measurement. Different from an existing communication service, generally, a quantity (that is, the number of several sensing measurement quantities that need to be reported, for example, signal strength and two sensing measurement quantities, that is, RSRP RSSI, are reported) and a size (that is, a data length of each sensing measurement quantity, or a total data length of a plurality of sensing measurement quantities if there are a plurality of sensing measurement quantities) of sensing measurement quantities in a specific time of sensing, reporting time and/or a reporting interval (that is, time for and a time interval for reporting sensing data (that is, a network may configure reporting start time and a reporting period during reporting performed a plurality of times)) are performed under an indication of network function configuration information. Therefore, the network knows a characteristic of the sensing data, and if a data type is indicated in the sensing QoS information, it helps a core network or a radio access side optimize resource configuration for sensing data transmission and reduce overheads. A definition of the type of sensing data may be provided based on a size of sensing data to be transmitted each time and/or transmission time (for example, transmitted in a slot of a subframe of a frame) and/or a transmission time interval (for example, transmitted once every 10 frames), such as a specified time interval+a specified data size (for example, data of X bytes is transmitted per 200 ms), a specified time interval (optionally, indicating a maximum data burst volume, without specifying a data size required for each transmission), and a specified data size (optionally, indicating shortest data burst time, without specifying a data interval length specifically required for each transmission).

### (3) Transmission Resource Type of Sensing Data

In integrated communication and sensing, a resource needs to meet both a communication requirement and a sensing requirement. A resource type may be defined based on a relationship between a sensing resource and a communication resource, for example, a sensing-specific resource and a resource shared by sensing and communication. Alternatively, a resource type may be defined based on a requirement for a final transmission effect, such as delay-critical, non-delay-critical, a guaranteed rate (guaranteed bit rate), a non-guaranteed bit rate, a guaranteed packet error rate, and/or a non-guaranteed packet error rate.

### (4) Packet Delay Budget in Sensing Data Transmission

An upper delay limit that can be tolerated when a data packet is transmitted between a sensing node (which may be a base station and/or UE) and a sensing function (SF) instance is defined.

### (5) Delay Jitter in Sensing Data Transmission

Maximum delay jitter that can be tolerated when a data packet is transmitted between the sensing node and the SF is defined, especially when the sensing function (SF) needs to perform processing jointly by using sensing measurement quantities of a plurality of base stations or UEs, the packet delay budget and the delay jitter jointly determine start time of calculation of a sensing result by the SF.

### (6) Packet Error Rate in Sensing Data Transmission

An upper limit of the packet error rate is defined as an upper rate limit in a case that a data packet has already been processed by a link layer of a transmit end but is not submitted to an upper layer by a corresponding receive end. A function of the packet error rate is to enable the network to configure suitable link layer parameters (for example, hybrid automatic repeat request (HARQ) configuration of radio link control (RLC)).

### (7) Burst Time of Sensing Data

A time length between two data transmissions is defined, and is limited to one or a combination of resource types in delay-critical, a guaranteed bit rate, and a guaranteed packet error rate.

### (8) Burst Volume of Sensing Data

A data volume is defined, and is applicable only to one or a combination of resource types in delay-critical, a guaranteed bit rate, and a guaranteed packet error rate.

The sensing data includes a measurement result of a sensing measurement quantity.

In this embodiment of this application, the sensing QoS information is decoupled from a sensing service. As the sensing service increases, better representability is possessed. In addition, the foregoing parameters are parameters that are easily parsed by a network function, and there are a limited quantity of sensing signal QoS parameters in the dimension of a sensing signal, where QoS represents relatively high efficiency.

In this embodiment of this application, there is a specific mapping relationship between the sensing QoS information and the sensing service, for example, the packet delay budget/delay jitter is related to a delay budget of the sensing service, update frequency during continuous sensing is related to a data type, and sensing accuracy is related to a packet error rate.

In this embodiment of this application, optionally, a value of at least one parameter in the sensing QoS information is represented by a value of a lowest requirement;
and/or
a value of at least one parameter in the sensing QoS information is represented by an interval, for example, is represented by an interval [X, Y], where an upper limit and a lower limit of the interval may or may not be included.

For example, in Embodiment 1, a value of at least one parameter in the sensing Qos information is represented by using a value of a lowest requirement, and the sensing Qos information includes at least one of the following:
a lowest priority of sensing data;
a type of sensing data;
a transmission resource type of sensing data;
a maximum packet delay budget;
maximum delay jitter;
a maximum packet error rate;
shortest data burst time; and
a maximum data burst volume.

It may be learned that, in the foregoing embodiment, a plurality of parameters are included in the sensing QoS information, and sending a large quantity of parameters is not conducive to communication efficiency. In this embodiment of this application, optionally, one sensing quality identifier (SQI) may be used to represent one sensing QoS information parameter combination, that is, the sensing QoS information is indicated by a sensing quality identifier value, and different values of the sensing quality identifier correspond to different sensing QoS information parameter combinations.

For example, in Embodiment 2, it is assumed that a manner of defining classification-based sensing QoS information is oriented. Based on this, a definition of a sensing quality identifier (SQI) is shown in Table 4.

TABLE 4
Standard SQI-to-QoS parameter mapping

| | Default | | Transmission | Maximum | | Maximum | Shortest | | | | |
|---|---|---|---|---|---|---|---|---|---|---|---|
| | priority | Type of | resource type | packet | | packet | data | | Maximum | | |
| SQI | of sensing | sensing | of sensing | delay | | error | burst | | data burst | | Service |
| value | data | data | data | budget | | rate | time | | volume | | example |
| 5 | 10 | Specified | Delay-critical | 1 | ms | 10e−6 | 5 | ms | 100 | M | Traffic |
| | | time interval | & guaranteed | | | | | | | | flow |
| | | | packet error | | | | | | | | monitoring |
| | | | rate | | | | | | | | |
| 10 | 20 | Specified | Delay-critical | 10 | ms | 10e−6 | 20 | ms | 30 | k | Respiration |
| | | time interval + | & guaranteed | | | | | | | | monitoring |
| | | specified | packet error | | | | | | | | |
| | | data size | rate | | | | | | | | |

It can be learned from Table 4 that when the SQI value is equal to 5 or 10, the sensing QoS information includes parameters such as a default priority of sensing data, a type of sensing data, and a transmission resource type of sensing data, and some parameters have corresponding values of a lowest requirement.

In this embodiment of this application, the SQI may also have another name, for example, a sensing service level. A value in the table is only used as an example, and may be another value, for example, may be defined by using a value interval. The parameter items in Table 4 are merely used an instance, and may be one or a combination of a plurality of items.

In this embodiment of this application, optionally, the sensing QoS information may also be indicated by using service level indication information, and different service level indication information correspond to different sensing QoS information parameter combinations.

In this embodiment of this application, optionally, the method for implementing sensing QoS further includes: sending, by the sensing function instance, the determined configuration information of the sensing data transmission to the first network function instance and/or the sensing node. The sensing node may be a terminal, or may be a base station.

In this embodiment of this application, optionally, the method for implementing sensing QoS further includes: performing, by the sensing function instance, at least one of the following based on the sensing QoS information:

### (1) Determining a Sensing Link.

The sensing link may be at least one of the following: a Uu link (a base station performs sending and UE performs receiving or a base station performs receiving and UE performs sending), a sidelink (one UE performs sending and another UE performs receiving), an echo link (a base station performs sending and receiving or UE performs sending and receiving), and a transceiver link between base stations (one base station performs sending and another base station performs receiving) (Note: one transmit end and one receive end are used as examples above, which may be extended to a plurality of transmit ends or receive ends).

### (2) Determining a Sensing Manner.

The sensing manner includes at least one of the following: a base station performs sending and UE performs receiving, a base station performs receiving and UE performs sending, sending and receiving between UEs, a base station performs sending and receiving, UE performs sending and receiving, and sending and receiving between base stations.

### (3) Determining a Sensing Signal.

In other words, the sensing signal is selected based on a received sensing request and/or algorithm. The sensing signal may be an existing reference signal (as shown in Table 5), may be a newly defined reference signal, or may be a data signal in a communication process. Therefore, one or more of the foregoing signals needs to be selected as the sensing signal.

TABLE 5
Existing reference signals that can be used as a sensing signal

| NR Down-Link RS | NR Up-Link RS | NR Sidelink RS |
|---|---|---|
| PDSCH-DMRS | PUSCH-DMRS | PSSCH-DMRS |
| PDCCH-DMRS | PUCCH-DMRS | PSCCH-DMRS |
| PBCH-DMRS | PTRS | PSSCH-PTRS |
| PT-RS | SRS | PSBCH-DMRS |
| CSI-RS | | CSI-RS |
| RIM-RS | | |
| P-RS | | |

### (4) Determining Configuration Information of a Sensing Signal.

For the selected sensing signal, a sensing signal on an air interface is configured, where configuration information includes at least one of the following: a frequency domain start location of the sensing signal, bandwidth of the sensing signal, a time domain start location of the sensing signal, a period of the sensing signal, trigger information of the sensing signal, a time domain distribution type of the sensing signal, a frequency domain distribution type of the sensing signal, and the like.

### (5) Determining a Sensing Node.

A base station and/or UE that participates in sensing are/is selected.

In this embodiment of this application, optionally, the method for implementing sensing QoS further includes: sending, by the sensing function instance, one or more of information about the determined sensing link and information about the sensing manner to the sensing node.

In this embodiment of this application, optionally, the sensing function instance sends an identifier of the sensing node to the first network function instance.

In this embodiment of this application, optionally, the obtaining, by the sensing function instance, the sensing QoS information includes:
receiving, by the sensing function instance, a sensing request; and
obtaining, by the sensing function instance, required sensing QoS information based on sensing QoS information in the sensing request.

If the sensing QoS information obtained by the sensing function instance from the sensing request meets a requirement, the sensing QoS information is directly used. If the sensing QoS information obtained by the sensing function instance from the sensing request does not meet the requirement, a specific type of required sensing QoS information may be generated based on the sensing QoS information obtained from the sensing request.

In this embodiment of this application, optionally, the obtaining, by the sensing function instance, required sensing QoS information based on the sensing QoS information in the sensing request includes:
mapping, by the sensing function instance, the sensing request into one or more groups of sensing QoS information.

The sensing function instance determines, based on the sensing QoS information in the received sensing request, that the sensing request is mapped into one or more groups of sensing QoS information. For example, when a geographic location range corresponding to a sensing request needs to be completed by a plurality of pairs of transmit nodes and receive nodes for sensing signals, for example, when a plurality of pairs of base stations and/or UEs send and receive sensing signals (for example, a base station A performs sending and UE X performs receiving; or a base station B performs sending and UE Y performs receiving), because the sensing QoS information is related to a transmit node and a receive node for transmission, sensing QoS information during transmission of each pair of transmit node and receive node needs to be determined. When a specific sensing request corresponds to a group of transmit nodes and receive nodes for sensing signals, and the sensing request includes transmission quality of different sensing data, the sensing function also needs to determine a plurality of groups of sensing QoS information.

In this embodiment of this application, optionally, the first network function instance is a session management function (SMF), and the sensing data transmission channel is a user plane protocol data unit (PDU) session;
or
the first network function instance is a target plane network function instance, the sensing data transmission channel is a target plane data transmission channel, and the target plane is a protocol function plane used to support at least one of data collection, data distribution, data security, data privacy, data analysis, and data preprocessing.

Optionally, the method further includes:
receiving, by the sensing function instance, a measurement result that is of a sensing measurement quantity and that is sent by a sensing node or the first network function instance;
generating, by the sensing function instance, a sensing result based on the measurement result; and
sending, by the sensing function instance, a sensing request response, where the sensing request response includes the sensing result.

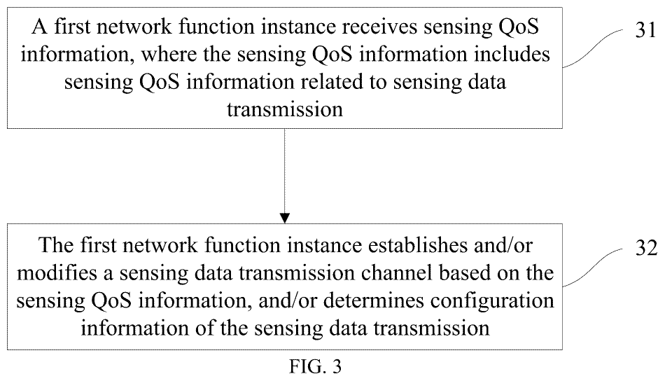

As shown in FIG. 3, an embodiment of this application further provides a method for implementing sensing QoS, including the following steps:

Step 31: A first network function instance receives sensing QoS information, where the sensing QoS information includes sensing QoS information related to sensing data transmission.

Step 32: The first network function instance establishes and/or modifies a sensing data transmission channel based on the sensing QoS information, and/or determines configuration information of the sensing data transmission.

In this embodiment of this application, the sensing data transmission channel can be established and/or modified based on the sensing QoS information, and/or the configuration information of the sensing data transmission can be determined, to help a sensing node complete reporting of a sensing measurement quantity to obtain a sensing result. Therefore, a sensing QoS requirement of a sensing service is met.

In this embodiment of this application, optionally, the configuration information of the sensing data transmission includes at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data;
a burst volume of sensing data;
a time-domain and/or frequency-domain resource used in sensing data transmission; and
a physical layer parameter used in sensing data transmission, including at least one of a modulation and coding scheme MCS, a precoding indication, a timing advance TA, and power.

In this embodiment of this application, optionally, the sensing QoS information includes at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data; and
a burst volume of sensing data; where
the sensing data includes a measurement result of a sensing measurement quantity.

In this embodiment of this application, optionally, a value of at least one parameter in the sensing QoS information is represented by a value of a lowest requirement;
and/or
a value of at least one parameter in the sensing QoS information is represented by an interval.

In this embodiment of this application, optionally, the sensing QoS information is indicated by using a sensing quality identifier value, and different values of the sensing quality identifier correspond to different combination of sensing QOS information parameters;
or
the sensing QoS information is indicated by using service level indication information, and different service level indication information corresponds to different sensing QoS information parameter combinations.

In this embodiment of this application, optionally, the method for implementing sensing QoS further includes: receiving, by the first network function instance, an identifier of a sensing node that is sent by the sensing function instance.

In this embodiment of this application, optionally, the method for implementing sensing QoS further includes:
receiving, by the first network function instance, a measurement result that is of a sensing measurement quantity and that is sent by a sensing node; and
sending, by the first network function instance, the measurement result to a sensing function instance.

In this embodiment of this application, optionally, the first network function instance is an SMF, and the sensing data transmission channel is a user plane PDU session;
or
the first network function instance is a target plane network function instance, the sensing data transmission channel is a target plane data transmission channel, and the target plane is a protocol function plane used to support at least one of data collection, data distribution, data security, data privacy, data analysis, and data preprocessing.

In this embodiment of this application, optionally, the first network function instance is an SMF; and
the establishing and/or modifying, by the first network function instance, a sensing data transmission channel based on the sensing QoS information includes:
receiving, by the SMF, a PDU session establishment request sent by an AMF, where the PDU session establishment request carries indication information used to indicate that the PDU is used for sensing data transmission;
selecting, by the SMF, a UPF based on the PDU session establishment request and the received sensing QoS information, and establishing or modifying a PDU session; and
sending, by the SMF, QoS parameter information used in the established PDU session to a sensing node.

In this embodiment of this application, optionally, the first network function instance is a target plane network function instance;
the establishing and/or modifying, by the first network function instance, a sensing data transmission channel based on the sensing QoS information includes:
establishing, by the target plane network function instance, a sensing data transmission channel with a sensing node based on the sensing QoS information; and
after the triggering, by the first network function instance, sensing data transmission channel establishment and/or modification based on the sensing QoS information, the method further includes:
sending, by the target plane network function instance, a data collection subscription message to the sensing node;
receiving, by the target plane network function instance, a measurement result that is of a sensing measurement quantity and that is reported by the sensing node; and
sending, by the target plane network function instance, the measurement result of the sensing measurement quantity to a sensing function instance.

In this embodiment of this application, optionally, the establishing and/or modifying, by the first network function instance, a sensing data transmission channel based on the sensing QoS information includes: mapping, by the first network function instance, the received sensing QoS information to one or more sensing data transmission channels.

The method for implementing sensing QoS in this application is described below with reference to specific embodiments.

### Embodiment 3: Method for Implementing Sensing QoS Based on a 5G Protocol Procedure

In this embodiment, sensing QoS interaction is supported based on extension of a QoS interaction procedure of a UE user plane in a 5G protocol, and is applicable to a case that UE receives and measures a sensing signal (for example, a base station sends a sensing signal and the UE receives the sensing signal, the UE sends and receives a sensing signal, or a sensing signal is sent and received between UEs).

The method for implementing sensing QoS is briefly described as follows:

Step 1: A sensing function (SF, which is a network function responsible for receiving a sensing request and providing a sensing result and may be another name) instance receives a sensing request, where the sensing request includes but is not limited to one or more of the following information:

### (1) Sensing QoS Class

For example, sensing QoS classes may be as follows:

Type I: Best effort type. That is, if a sensing result cannot meet a QoS indicator requirement, a sensing result needs to be fed back, but an indication is required to indicate that requested QoS is not met; and if the sensing result is not obtained, a fault cause is fed back.

Type II: Multi-QoS type. That is, QoS indicator requirements corresponding to a plurality of QoS classes are included. If a sensing result does not meet the most stringent QoS indicator requirement, the SF initiates a sensing procedure again, to attempt to meet a lower QoS indicator requirement until one of the QoS indicator requirements is met. If the least stringent QoS indicator requirement is still not met, the SF does not feed back a sensing result, but feeds back only a failure cause.

Type III: Assured type, which is the most stringent sensing QoS class. If a sensing result does not meet a QoS indicator requirement, a sensing result is not fed back, and only a failure cause is fed back.

### (2) Sensing Service Type

The sensing service type may be defined in the following manner:
a) The sensing service type may be defined based on bandwidth and a time domain duration requirement of a sensing signal. For example, Type I is a high-bandwidth continuity sensing service (a plurality of sensing results are provided based on specified time, a geographic location, and the like); Type II is a large-bandwidth one-time sensing service (providing one sensing result); Type III is a low-bandwidth continuity sensing service; Type IV is a low-bandwidth one-time sensing service.
b) The sensing service type may be defined based on delay and bandwidth requirements for sensing data transmission. For example, Type I is a high-bandwidth sensing service (sensing data transmission has a higher bandwidth or guaranteed bit rate requirement); Type II is a low-delay sensing service (sensing data transmission requires a relatively low packet delay budget); Type III is a high-bandwidth and low-delay sensing service (having both of the foregoing two requirements); and Type IV is a sensing service with uncritical transmission quality (having no special requirement for quality of sensing data transmission).
c) Alternatively, the sensing service type may be correspondingly defined based on a quality of service type or class (QOS class).
d) Alternatively, the sensing service type may be defined based on a physical sensing range and a real-time performance requirement. For example, Type I: Large sensing range and high real-time performance requirement (Delay Critical LSS); Type II: Large sensing range and low real-time performance requirement (LSS); Type III: Small sensing range and low real-time performance requirement (Delay Critical SSS); Type IV: Small sensing range and low real-time performance requirement (SSS).

### (3) Response Time Type

Response time requirements may be classified into one or more of the following type:

No delay type: The SF should immediately feed back a sensing result of a sensing target. If there is no sensing result, failure information is fed back, and a sensing procedure may be triggered to respond to a subsequent sensing request.

Low delay type: Compared with accuracy, a response time requirement is preferably met. The SF should return a current sensing result with a minimum delay.

Delay insensitive class: Compared with response time, an accuracy requirement is preferably met. The SF may delay the feedback of a sensing result until a required sensing QoS requirement is met.

### (4) Sensing Object

Sensing objects may be classified into per object (a sensing service using a sensing target such as UE as a sensing object) and per area (a sensing service using a geographic area such as an airport area as a sensing object).

### (5) Quality of Service Requirement for a Sensing Service

Quality of service requirements for a sensing service include but are not limited to at least one of sensing accuracy, sensing resolution, a sensing error, a sensing range, a sensing delay, a detection probability, and a false alarm probability. The sensing resolution may be distance resolution, imaging resolution, moving speed resolution, angle resolution, respiration resolution, frequency resolution, or rainfall capacity resolution based on different sensing services. The sensing error may be a distance error, an imaging error, a moving speed error, a respiration quantity error, a recognition accuracy rate, or a rainfall capacity error in a case that a specific confidence is met based on different sensing services.

(6) The sensing QoS information includes at least one of the following: a sensing service QoS parameter, a sensing measurement quantity QoS parameter, a sensing signal QoS parameter, and a sensing data transmission QoS parameter. If the sensing request received by the SF does not include a specific type of sensing QoS information, the SF may also generate, based on the received sensing QoS information, a required type of sensing QoS information.
Step 2: The SF sends the sensing QOS information (including sensing QoS information related to sensing data transmission) to a session management function (SMF). In addition to the sensing QoS information, this message may further include an identifier of UE configured to perform sensing measurement and the like.

In this step, the SF may interact with an AMF to obtain the SMF.
Step 3: The SF sends sensing configuration information to the UE that participates in sensing, where the sensing configuration information is a sensing manner, a sensing measurement quantity such as RSRP, a sensing measurement quantity reporting manner (that is, a sensing data type, such as specified time+specified size), or the like.

There is no strict sequence relationship between step 2 and step 3.
Step 4: The UE initiates a PDU session establishment request based on the received sensing configuration information by using a NAS message, where the request message includes one or more of a UE identifier (such as a SUPI), information indicating that the PDU is used for sensing data transmission, and the foregoing received SF information.
Step 5: The AMF selects the SMF based on the PDU session establishment request, and sends a creation message through an interface between the AMF and the SMF, and the SMF sends a creation response. If PDU session authentication or authorization is required, related information interaction is required.
Step 6: The SMF selects the UPF based on received creation request information/context and/or the SF information received in step 2, and sends a used QoS control parameter to the UPF through N4 interface session establishment or session modification, for example, a packet detection rule (PDR). The PDR parameter includes at least of an ID identifying an N4 session associated with the PDR, an ID uniquely identifying this rule, a sequence of detection information to determine to use all rules, data packet detection information (including a QoS flow ID, a UE IP address, CN tunnel information, and the like), a forwarding behavior operation that must be implemented (for example, forwarding to a sensing function), a measurement behavior that must be implemented (for example, a packet transmission delay or a packet error rate of sensing), and the like.
Step 7: The SMF sends, by using the AMF and an (R)AN (that is, a NAS message), QoS parameter information used by the UE on the established PDU session, for example, a QoS rule. If the QoS flow is related to the QoS rule, a QoS parameter of the QoS flow further needs to be sent. The QoS rule may be defined based on an existing QoS rule, so that a sensing QFI and a communication QFI need to be distinguished, and a mapping relationship between the QoS rule and the sensing QFI includes an explicit manner (for example, explicitly provided to the UE in a PDU session establishment/modification process), an implicit manner, or the like (for example, reflective QoS).
Step 8: The SMF sends, by using the AMF and an N2 interface between the SMF and the (R)AN, QOS parameter information used by the gNB on the established PDU session, such as QoS Profile.
Step 9: RRC signaling of the (R)AN is not only responsible for bearing the NAS message, but also responsible for establishing a transmission channel from the base station to the UE. For example, a DRB is established by using an RRC reconfiguration procedure, and a mapping relationship between the DRB and an RLC mode, a logical channel, and a transmission channel further needs to be configured by using the RRC signaling. QoS of the DRB is defined by the base station, and the DRB and the QoS flow are in a one-to-many mapping relationship. The base station completes mapping from one or more QoS flows in the foregoing PDU session to the DRB. Considering a difference (such as a data type, for example, a specified time or a specified size of sensing data) between sensing data and communication data, preferably, there are at least two types of QoS flows on a base station side: a sensing QoS flow and a communication QoS flow. The sensing QoS flow may be mapped to the DRB in a one-to-one manner, to ensure isolation between different sensing services. When sensing data types are the same, a plurality of sensing QoS flows of data of a same type may also be mapped to a same DRB.
Step 10: The UE reports a measurement result of a sensing measurement quantity of the sensing signal by using the foregoing sensing PDU session, and the UPF forwards the measurement result of the sensing measurement quantity to the SF based on the PDR.
Step 11: The SF generates a sensing result based on the measurement result of the sensing measurement quantity, and responds to the sensing request.

In Embodiment 3 of this application, only sensing data transmission between the UE and the SF is used as an example, and sensing QoS interaction based on a 5G protocol procedure may also support sensing data transmission between the base station and the SF. If the sensing data transmission between the base station and the SF is supported, the sensing data transmission channel is a channel between the base station and the SF, and may reuse the N2 interface or may be a newly created interface.

### Embodiment 4: Target Plane-Based Method for Implementing Sensing QoS

Because sensing data is different from service data carried in existing communication, in this embodiment of this application, sensing data transmission is supported by using a newly added target plane. The newly added target plane is used as a protocol function plane that is added on a basis of a control plane (CP) and a user plane (UP) and that is used to support at least one of data collection, data distribution, data security, data privacy, data analysis, and data preprocessing. The target plane may also be referred to as a data plane. The newly added target plane may be terminated not only on a core network target plane function but also on a radio access network target plane function.

The target plane-based method for implementing sensing QoS in this embodiment is applicable to a case that UE receives and measures a sensing signal (for example, a base station sends the sensing signal and the UE receives the sensing signal, the UE sends and receives the sensing signal, or the sensing signal is sent/received between UEs). An interaction procedure of the method for implementing sensing QoS is briefly described as follows:
Step 1: The same as that in Embodiment 3, and not described again.
Step 2: The SF sends sensing QoS information to a core network target plane function instance to request data transmission. Optionally, if the SF has selected UE and a base station that are used for sensing, this message may further include one or more of an identifier of the UE, an identifier of the base station, and a sensing measurement quantity that needs to be reported by the UE.
Step 3: The core network target plane function instance sends a data collection subscription message to the UE based on the received information and/or another data collection and/or data transmission request by using a target plane message, where the message includes a data item and/or a data reporting interval.
Step 4: The core network target plane function instance establishes a sensing data transmission channel based on a data transmission requirement. A manner of establishing the sensing data transmission channel may be one of the following: a per UE channel between the core network target plane function instance and the UE, a per node channel between the core network target plane function instance and the base station+a channel between the UE and a radio access network target plane instance, and a per node channel between the core network target plane function instance and the base station+a connection-free channel between the UE and a radio access network.
Step 5: The UE reports a measurement result of a sensing measurement quantity to the core network target plane function instance or the radio access network target plane instance.
Step 6: The core network target plane function instance sends the measurement result of the sensing measurement quantity to the SF.
Step 7: The SF generates a sensing result based on the measurement result of the sensing measurement quantity, and responds to the sensing request.

It should be noted that, in the foregoing embodiment, that the core network target plane function instance establishes the sensing data transmission channel is used as an example for description. In some other embodiments, the sensing data transmission channel may be alternatively established by the radio access network target plane function instance.

### Embodiment 5 Method for Mapping Sensing QoS

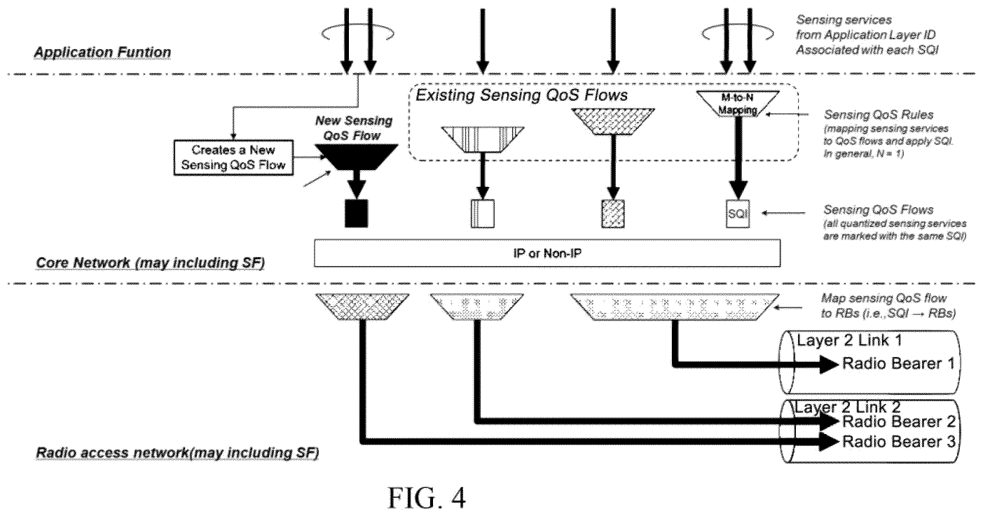

This embodiment is used to describe a mapping relationship between sensing QoS used by network functions. As shown in FIG. 4, related information is briefly described as follows:

First, a sensing function (SF) receives a sensing request of an application function, and QoS information in the sensing request may be represented by using a standard SQI, or sensing QoS information indicated by a service level may be indirectly represented in a service-level agreement (SLA) manner. For example, in an SLA protocol with a supplier of an application A, it is indicated that sensing QoS information corresponding to a sensing request of an application function A may be represented by using a parameter proposed in the proposal of this application, and a representation method may be defined in a manner of Embodiment 1 and/or Embodiment 2.

Second, it is assumed that the foregoing sensing request is represented in an SQI manner, and a network function determines, based on the sensing QoS information in the received sensing request, that the sensing request is mapped into one or more groups of sensing data transmission QoS parameters (that is, sensing QoS information related to sensing data transmission), where each group of sensing data transmission QoS parameters may be one or more of the foregoing defined sensing data transmission QoS parameters. For example, when a geographic location range corresponding to a sensing request needs to be completed by a plurality of pairs of transmit nodes and receive nodes for sensing signals, for example, when a plurality of pairs of base stations and/or UEs send and receive sensing signals (for example, a base station A performs sending and UE X performs receiving; or a base station B performs sending and UE Y performs receiving), because a sensing data transmission QoS parameter is related to a transmit node and a receive node for transmission, a sensing data transmission QoS parameter during transmission of each pair of transmit node and receive node needs to be determined. When a specific sensing request corresponds to a group of transmit nodes and receive nodes for sensing signals, and the sensing request includes transmission quality of different sensing data, the sensing function also needs to determine a plurality of sets of sensing data transmission QoS parameters. The one or more groups of sensing data transmission QoS parameters (assuming that each group of sensing data transmission QoS parameters is represented by an SQI) may be mapped to an existing sensing data transmission channel if there is already a transmission channel between a transmit node and a receive node of the sensing signal that meets a requirement of the sensing data transmission QoS parameter. If the existing transmission channel cannot meet a QoS requirement of sensing data transmission, a new sensing data transmission channel is established. Therefore, the sensing function may determine one or more SQIs based on one sensing request, and each SQI may be mapped to one core network transmission channel, or a plurality of SQIs are mapped to one core network transmission channel. A plurality of SQIs corresponding to a plurality of sensing requests may also be mapped to one core network transmission channel if a transmit node and a receive node for sensing data are the same.

Note: In the accompanying drawings of the specification, a sensing QoS flow is used as an example to represent a core network transmission channel. The core network transmission channel may alternatively include a plurality of QoS flows.

Finally, on a radio access network side, based on one or more pieces of received SQI information (which may be represented by using a parameter in this application and in a manner of Embodiment 1 and/or Embodiment 2) on a core network transmission channel, it is determined that one or more SQIs of the core network transmission channel are mapped into one or more radio bearers (RB) (the bearer may be an existing DRB and/or SRB, or may be a newly added target plane bearer), and radio access networks corresponding to the RBs have different transmission QoS. Therefore, core network transmission channels and RBs are in an M-to-N mapping relationship, and one core network transmission channel is mapped to 1 to N RBs. A plurality of core network transmission channels may be mapped to one RB.

In Embodiment 5, that the UE is used as a sensing signal receiving node and performs measurement is used as an example, and this may also be extended to a case that a base station is used as the sensing signal receiving node and performs measurement.

The method for implementing sensing QoS provided in the embodiments of this application may be performed by an apparatus for implementing sensing QoS. In the embodiments of this application, the apparatus for implementing sensing QoS provided in the embodiments of this application is described by using an example in which the apparatus for implementing sensing QoS performs the method for implementing sensing QoS.

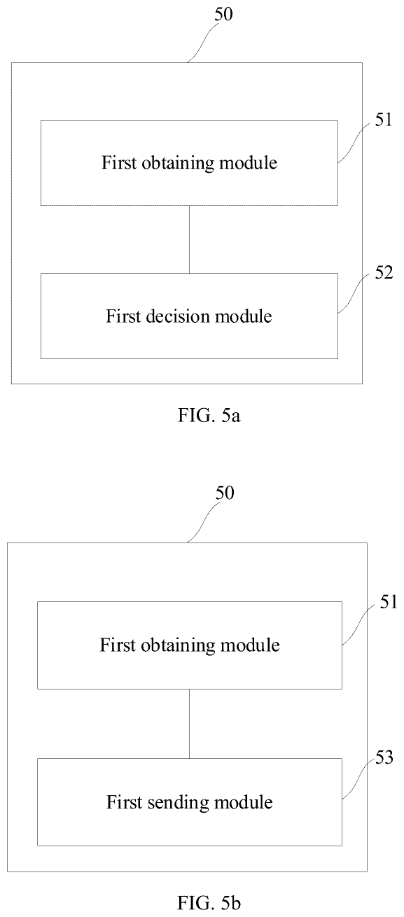

As shown in FIG. 5a and FIG. 5b, an embodiment of this application further provides an apparatus 50 for implementing QoS sensing, including:
a first obtaining module 51, configured to obtain sensing QoS information, where the sensing QoS information includes sensing QoS information related to sensing data transmission; and
a first decision module 52, configured to determine configuration information of the sensing data transmission based on the sensing QoS information; or a first sending module 53, configured to send the sensing QoS information to a first network function instance.

In this embodiment of this application, the configuration information of the sensing data transmission can be determined based on the sensing QoS information, or the sensing QoS information is sent to the first network function instance, to trigger the first network function instance to establish and/or modify a sensing data transmission channel, thereby helping a sensing node complete reporting of a sensing measurement quantity to obtain a sensing result. Therefore, a sensing QoS requirement of a sensing service is met.

Optionally, the configuration information of the sensing data transmission includes at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data;
a burst volume of sensing data;
a time-domain and/or frequency-domain resource used in sensing data transmission; and
a physical layer parameter used in sensing data transmission, including at least one of a modulation and coding scheme MCS, a precoding indication, a timing advance TA, and power.

Optionally, the sensing QoS information includes at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data; and
a burst volume of sensing data; where
the sensing data includes a measurement result of a sensing measurement quantity.

Optionally, a value of at least one parameter in the sensing QoS information is represented by a value of a lowest requirement;
and/or
a value of at least one parameter in the sensing QoS information is represented by an interval.

Optionally, the sensing QoS information is indicated by using a sensing quality identifier value, and different values of the sensing quality identifier correspond to different sensing QoS information parameter combinations;
or
the sensing QoS information is indicated by using service level indication information, and different service level indication information corresponds to different sensing QoS information parameter combinations.

Optionally, the apparatus 50 for implementing sensing QoS further includes:
a second sending module, configured to send the determined configuration information of the sensing data transmission to the first network function instance and/or a sensing node.

Optionally, the apparatus 50 for implementing sensing QoS further includes:
a second decision module, configured to perform at least one of the following based on the sensing QoS information:
determining a sensing link;
determining a sensing manner; and
determining a sensing node.

Optionally, the apparatus 50 for implementing sensing QoS further includes:
a third sending module, configured to send one or more of information about the determined sensing link and information about the sensing manner to the sensing node.

Optionally, the apparatus 50 for implementing sensing QoS further includes:
a fourth sending module, configured to send an identifier of the sensing node to the first network function instance.

Optionally, the first obtaining module 51 is configured to: receive a sensing request; and obtain required sensing QoS information based on sensing QoS information in the sensing request.

Optionally, the first obtaining module 51 is configured to map the sensing request into one or more groups of sensing QoS information.

Optionally, the first network function instance is an SMF, and the sensing data transmission channel is a user plane PDU session;
or
the first network function instance is a target plane network function instance, the sensing data transmission channel is a target plane data transmission channel, and the target plane is a protocol function plane used to support at least one of data collection, data distribution, data security, data privacy, data analysis, and data preprocessing.

Optionally, the apparatus 50 for implementing sensing QoS further includes:
a first receiving module, configured to receive a measurement result that is of a sensing measurement quantity and that is sent by a sensing node or the first network function instance;
a generation module, configured to generate a sensing result based on the measurement result; and
a fifth sending module, configured to send a sensing request response, where the sensing request response includes the sensing result.

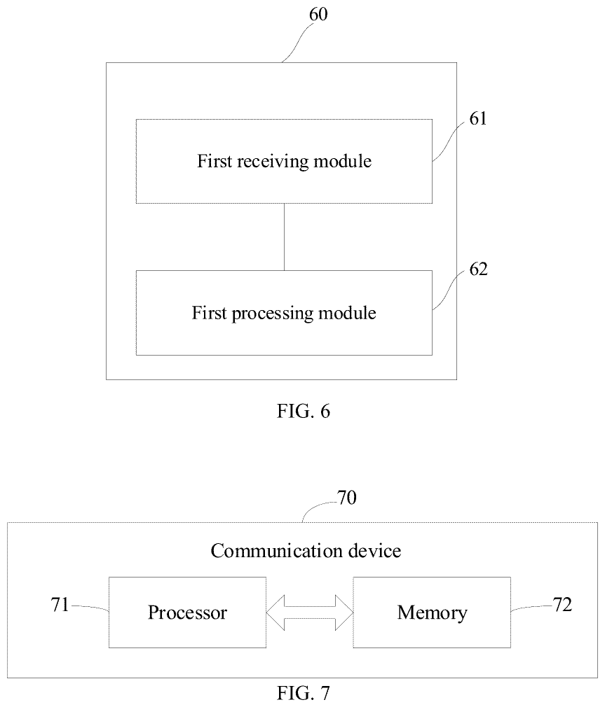

As shown in FIG. 6, an embodiment of this application further provides an apparatus 60 for implementing QoS sensing, including:
a first receiving module 61, configured to receive sensing QoS information, where the sensing QoS information includes sensing QoS information related to sensing data transmission; and
a first processing module 62, configured to: establish and/or modify a sensing data transmission channel based on the sensing QoS information, and/or determine configuration information of the sensing data transmission.

In this embodiment of this application, the sensing data transmission channel can be established and/or modified based on the sensing QoS information, and/or the configuration information of the sensing data transmission can be determined, to help a sensing node complete reporting of a sensing measurement quantity to obtain a sensing result. Therefore, a sensing QoS requirement of a sensing service is met.

Optionally, the configuration information of the sensing data transmission includes at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data; and
a burst volume of sensing data.
a time-domain and/or frequency-domain resource used in sensing data transmission; and
a physical layer parameter used in sensing data transmission, including at least one of a modulation and coding scheme MCS, a precoding indication, a timing advance TA, and power.

Optionally, the sensing QoS information includes at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data; and
a burst volume of sensing data; where
the sensing data includes a measurement result of a sensing measurement quantity.

Optionally, a value of at least one parameter in the sensing QoS information is represented by a value of a lowest requirement;
and/or
a value of at least one parameter in the sensing QoS information is represented by an interval.

Optionally, the sensing QoS information is indicated by using a sensing quality identifier value, and different values of the sensing quality identifier correspond to different sensing QoS information parameter combinations;
or
the sensing QoS information is indicated by using service level indication information, and different service level indication information corresponds to different sensing QoS information parameter combinations.

Optionally, the apparatus 60 for implementing sensing QoS further includes:
a second receiving module, configured to receive an identifier of a sensing node that is sent by a sensing function instance.

Optionally, the apparatus 60 for implementing sensing QoS further includes:
a third receiving module, configured to receive a measurement result of a sensing measurement quantity sent by a sensing node; and
a first sending module, configured to send the measurement result to the sensing function instance.

Optionally, the first network function instance is an SMF, and the sensing data transmission channel is a user plane PDU session;
or
the first network function instance is a target plane network function instance, the sensing data transmission channel is a target plane data transmission channel, and the target plane is a protocol function plane used to support at least one of data collection, data distribution, data security, data privacy, data analysis, and data preprocessing.

Optionally, the first network function instance is an SMF; and
the first processing module 62 is configured to: receive a PDU session establishment request sent by an AMF, where the PDU session establishment request carries indication information used to indicate that the PDU is used for sensing data transmission; select a UPF and perform PDU session establishment or session modification based on the PDU session establishment request and the received sensing QoS information; and send, to a sensing node, QoS parameter information used in an established PDU session.

Optionally, the first network function instance is a target plane network function instance;
the first processing module 62 is configured to establish a sensing data transmission channel with a sensing node based on the sensing QoS information; and
the apparatus 60 for implementing sensing QoS further includes:
a second sending module, configured to send a data collection subscription message to the sensing node;
a third receiving module, configured to receive a measurement result that is of a sensing measurement quantity and that is reported by the sensing node; and
a third sending module, configured to send the measurement result of the sensing measurement quantity to the sensing function instance.

Optionally, the first processing module 62 is configured to map the received sensing QoS information to one or more sensing data transmission channels.

The apparatus for implementing sensing QoS provided in this embodiment of this application can implement the processes implemented in the method embodiment in FIG. 3, and a same technical effect is achieved. To avoid repetition, details are not described herein again.

Optionally, as shown in FIG. 7, an embodiment of this application further provides a communication device 70, including a processor 71 and a memory 72, and the memory 72 stores a program or an instruction that can be run on the processor 71. When the program or the instruction is executed by the processor 71, the steps of the embodiment of the foregoing method for implementing sensing QoS are implemented, and a same technical effect is achieved. To avoid repetition, details are not described herein again.

An embodiment of this application further provides a network side device, including a processor and a communication interface. The processor is configured to: obtain sensing QoS information, where the sensing QoS information includes sensing QoS information related to sensing data transmission; and determine configuration information of the sensing data transmission based on the sensing QoS information. Alternatively, the communication interface is configured to send the sensing QoS information to a first network function instance. This embodiment of the network side device is corresponding to the embodiment of the foregoing method for implementing sensing QoS performed by the sensing function instance. Each implementation process and implementation manner of the foregoing method embodiment may be applicable to this embodiment of the network side device, and a same technical effect can be achieved.

An embodiment of this application further provides a network side device, including a processor and a communication interface. The communication interface is configured to receive sensing QoS information, where the sensing QoS information includes sensing QoS information related to sensing data transmission. The processor is configured to establish and/or modify a sensing data transmission channel based on the sensing QoS information, and/or determine configuration information of the sensing data transmission. This embodiment on the network side device is corresponding to the foregoing embodiment of the method for implementing sensing QoS performed by the first network function instance. Each implementation process and implementation manner of the foregoing method embodiment may be applicable to this embodiment on the network side device, and a same technical effect can be achieved.

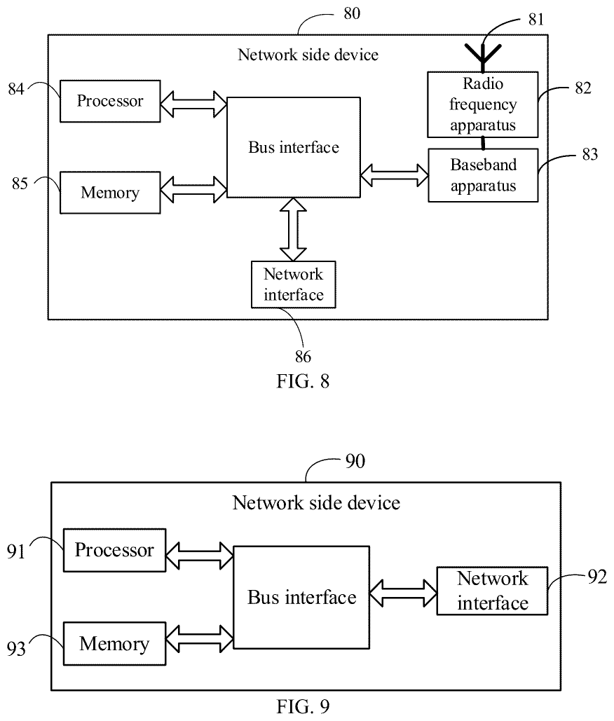

Specifically, an embodiment of this application further provides a network side device. As shown in FIG. 8, the network side device 80 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

In the foregoing embodiment, the method performed by the network side device may be implemented in a baseband apparatus 83. The baseband apparatus 83 includes a baseband processor.

For example, the baseband apparatus 83 may include at least one baseband board. A plurality of chips are disposed on the baseband board. As shown in FIG. 8, one chip is, for example, a baseband processor, and is connected to the memory 85 by using a bus interface, to invoke a program in the memory 85 to perform the operations of the network device shown in the foregoing method embodiment.

The network side device may further include a network interface 86, and the interface is, for example, a common public radio interface (CPRI).

Specifically, the network side device 80 in this embodiment of the present invention further includes an instruction or a program that is stored in the memory 85 and that can be run on the processor 84, and the processor 84 invokes the instruction or the program in the memory 85 to perform the methods performed by the modules shown in FIG. 5a, FIG. 5b, or FIG. 6, and a same technical effect is achieved. To avoid repetition, details are not described herein again.

Specifically, an embodiment of this application further provides a network side device. As shown in FIG. 9, the network side device 90 includes a processor 91, a network interface 92, and a memory 93. The network interface 92 is, for example, a common public radio interface (CPRI).

Specifically, the network side device 90 in this embodiment of the present invention further includes an instruction or a program that is stored in the memory 93 and that can be run on the processor 91, and the processor 91 invokes the instruction or the program in the memory 93 to perform the methods performed by the modules shown in FIG. 5a, FIG. 5b, or FIG. 6, and a same technical effect is achieved. To avoid repetition, details are not described herein again.

An embodiment of this application further provides a readable storage medium. The readable storage medium stores a program or an instruction, and when the program or the instruction is executed by a processor, the processes of the embodiment of the foregoing method for implementing sensing QoS are implemented, and a same technical effect can be achieved. To avoid repetition, details are not described herein again.

The readable storage medium includes a computer-readable storage medium, such as a computer read-only memory (ROM), a random-access memory (RAM), a magnetic disk, or an optical disc.

An embodiment of this application further provides a chip. The chip includes a processor and a communication interface, the communication interface is coupled to the processor, and the processor is configured to run a program or an instruction to implement the processes of the embodiment of the foregoing method for implementing sensing QoS, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a non-volatile storage medium, and the computer program/program product is executed by at least one processor to implement the processes of the embodiment of the foregoing method for implementing sensing QoS, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “including a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for implementing sensing quality of service (QOS), comprising:
obtaining, by a sensing function instance, sensing QoS information, wherein the sensing Qos information comprises sensing QoS information related to sensing data transmission; and
determining, by the sensing function instance, configuration information of the sensing data transmission based on the sensing QoS information, or sending the sensing QoS information to a first network function instance.

2. The method according to claim 1, wherein the configuration information of the sensing data transmission comprises at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data;
a burst volume of sensing data;
a time-domain and/or frequency-domain resource used in sensing data transmission; or
a physical layer parameter used in sensing data transmission, comprising at least one of a modulation and coding scheme (MCS), a precoding indication, a timing advance (TA), or power.

3. The method according to claim 1, wherein the sensing QoS information comprises at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data; or
a burst volume of sensing data;
wherein the sensing data comprises a measurement result of a sensing measurement quantity.

4. The method according to claim 1, wherein
a value of at least one parameter in the sensing QoS information is represented by a value of a lowest requirement; and/or
a value of at least one parameter in the sensing QoS information is represented by an interval.

5. The method according to claim 1, wherein
the sensing QoS information is indicated by using a sensing quality identifier value, and different values of the sensing quality identifier correspond to different sensing Qos information parameter combinations; or
the sensing QoS information is indicated by using service level indication information, and different service level indication information corresponds to different sensing QoS information parameter combinations.

6. The method according to claim 1, further comprising:
sending, by the sensing function instance, the determined configuration information of the sensing data transmission to the first network function instance and/or a sensing node.

7. The method according to claim 1, further comprising:
performing, by the sensing function instance, at least one of the following based on the sensing QoS information:
determining a sensing link;
determining a sensing manner; or
determining a sensing node.

8. The method according to claim 7, further comprising:
sending, by the sensing function instance, one or more of information about the determined sensing link and information about the sensing manner to the sensing node;
or,
wherein the method further comprises:
sending, by the sensing function instance, an identifier of the sensing node to the first network function instance.

9. The method according to claim 1, wherein the obtaining, by a sensing function instance, sensing QoS information comprises:
receiving, by the sensing function instance, a sensing request; and
obtaining, by the sensing function instance, required sensing QoS information based on sensing QoS information in the sensing request;
wherein the obtaining, by the sensing function instance, required sensing QoS information based on sensing QoS information in the sensing request comprises:
mapping, by the sensing function instance, the sensing request into one or more groups of sensing QoS information.

10. The method according to claim 1, wherein
the first network function instance is a session management function (SMF); or
the first network function instance is a target plane network function instance, and the target plane is a protocol function plane used to support at least one of data collection, data distribution, data security, data privacy, data analysis, or data preprocessing; or,
wherein the method further comprises:
receiving, by the sensing function instance, a measurement result that is of a sensing measurement quantity and that is sent by a sensing node or the first network function instance;
generating, by the sensing function instance, a sensing result based on the measurement result; and
sending, by the sensing function instance, a sensing request response, wherein the sensing request response comprises the sensing result.

11. A method for implementing sensing QoS, comprising:
receiving, by a first network function instance, sensing QoS information, wherein the sensing QoS information comprises sensing QoS information related to sensing data transmission; and
establishing and/or modifying, by the first network function instance, a sensing data transmission channel based on the sensing QoS information, and/or determining configuration information of the sensing data transmission.

12. The method according to claim 11, wherein the configuration information of the sensing data transmission comprises at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data;
a burst volume of sensing data;
a time-domain and/or frequency-domain resource used in sensing data transmission; or
a physical layer parameter used in sensing data transmission, comprising at least one of a modulation and coding scheme (MCS), a precoding indication, a timing advance (TA), or power.

13. The method according to claim 11, wherein the sensing QoS information comprises at least one of the following:
a priority of sensing data;
a type of sensing data;
a transmission resource type of sensing data;
a packet delay budget in sensing data transmission;
delay jitter in sensing data transmission;
a packet error rate in sensing data transmission;
burst time of sensing data; or
a burst volume of sensing data; wherein
the sensing data comprises a measurement result of a sensing measurement quantity.

14. The method according to claim 11, wherein
a value of at least one parameter in the sensing QoS information is represented by a value of a lowest requirement; and/or
a value of at least one parameter in the sensing QoS information is represented by an interval;
or,
wherein the sensing QoS information is indicated by using a sensing quality identifier value, and different values of the sensing quality identifier correspond to different sensing QoS information parameter combinations; or
the sensing QoS information is indicated by using service level indication information, and different service level indication information corresponds to different sensing QoS information parameter combinations.

15. The method according to claim 11, further comprising:
receiving, by the first network function instance, an identifier of a sensing node that is sent by a sensing function instance;
or,
wherein the method further comprises:
receiving, by the first network function instance, a measurement result that is of a sensing measurement quantity and that is sent by a sensing node; and
sending, by the first network function instance, the measurement result to a sensing function instance.

16. The method according to claim 11, wherein
the first network function instance is a session management function (SMF), and the sensing data transmission channel is a user plane PDU session; or
the first network function instance is a target plane network function instance, the sensing data transmission channel is a target plane data transmission channel, and the target plane is a protocol function plane used to support at least one of data collection, data distribution, data security, data privacy, data analysis, or data preprocessing.

17. The method according to claim 16, wherein the first network function instance is an SMF; and
the establishing and/or modifying, by the first network function instance, a sensing data transmission channel based on the sensing QoS information comprises:
receiving, by the SMF, a PDU session establishment request sent by an access and mobility management function (AMF), wherein the PDU session establishment request carries indication information used to indicate that a PDU is used for sensing data transmission;
selecting, by the SMF, a UPF based on the PDU session establishment request and the received sensing QoS information, and establishing or modifying a PDU session; and
sending, by the SMF, QoS parameter information used in the established PDU session to a sensing node;
or,
wherein the first network function instance is a target plane network function instance; and
the establishing and/or modifying, by the first network function instance, a sensing data transmission channel based on the sensing QoS information comprises:
establishing, by the target plane network function instance, a sensing data transmission channel with a sensing node based on the sensing QoS information; and
after the triggering, by the first network function instance, sensing data transmission channel establishment and/or modification based on the sensing QoS information, the method further comprises:
sending, by the target plane network function instance, a data collection subscription message to the sensing node;
receiving, by the target plane network function instance, a measurement result that is of a sensing measurement quantity and that is reported by the sensing node; and
sending, by the target plane network function instance, the measurement result of the sensing measurement quantity to a sensing function instance.

18. The method according to claim 11, wherein the establishing and/or modifying, by the first network function instance, a sensing data transmission channel based on the sensing QoS information comprises:
mapping, by the first network function instance, the received sensing QoS information to one or more sensing data transmission channels.

19. A communication device, comprising a processor and a memory, wherein the memory stores a program or an instruction that can be run on the processor, wherein the program or the instruction, when executed by the processor, causes the communication device to perform:
obtaining sensing QoS information, wherein the sensing QoS information comprises sensing QoS information related to sensing data transmission; and
determining configuration information of the sensing data transmission based on the sensing QoS information, or sending the sensing QoS information to a first network function instance.

20. A communication device, comprising a processor and a memory, wherein the memory stores a program or an instruction that can be run on the processor, and when the program or the instruction is executed by the processor, the steps of the method for implementing sensing QoS according to claim 11 are implemented.
